(19) United States
(12) Patent Application Publication
(10) Pub. No.: US 2013/0210974 A1
(43) Pub. Date: Aug. 15, 2013

(54) Plasticized Polyvinyl Chloride Composition with Flame Retardant

(71) Applicant: James F. Day, Winston-Salem, NC (US)

(72) Inventor: James F. Day, Winston-Salem, NC (US)

(73) Assignee: LANXESS CORPORATION, Pittsburgh, PA (US)

(21) Appl. No.: 13/613,306

(22) Filed: Sep. 13, 2012

Related U.S. Application Data
(63) Continuation of application No. 11/970,633, filed on Jan. 8, 2008, now abandoned.

(51) Int. Cl. C08K 5/1539

(52) U.S. Cl. CPC C08K 5/1539
USPC 524/112

(57) ABSTRACT

A highly flame retardant plasticized polyvinyl chloride composition includes a mixture of a dialkyl or dialkenyl tetrahalophthalate and a brominated/chlorinated paraffin. The composition exhibits an absence of brittleness, and substantial flexibility at low temperatures. The composition can be used to form sheet materials, molding compositions, roofing materials, PVC formed jackets and insulation for wire and cable products.

### FIELD OF THE INVENTION

This invention relates to a highly flame retardant, plasticized polyvinyl chloride (PVC) composition characterized by an absence of brittleness at low temperatures, substantial flexibility and low smoke properties. PVC formulations of the invention can be used for molding compositions, sheet materials, coating materials and electrical insulation materials. The composition of the invention is also suitable for PVC formed jackets, insulation for wire and cable products and roof sheathing.

### BACKGROUND OF THE INVENTION

PVC compounds are a well known class of thermoplastic polymers which exhibit excellent chemical and corrosion resistance, physical and mechanical strength, and electrical insulative properties. Unplasticized versions of PVC are inherently flame resistant, and rigid PVC compounds require only additional antimony trioxide to achieve a high level of flame retardancy. When flexible forms of PVC are required, however, the addition of plasticizers to the formulation can increase its flammability. Conventional PVC is also apt to produce excessive smoke when exposed to ignition temperatures.

As is well known in the art, flame retardants must be in liquid form to plasticize PVC. See, Handbook of Polyvinyl Chloride Formulating, edited by Edward J. Wickson, 818-831, John Wiley & Sons (1993). The disclosure of this publication and all other publications and patents referred to herein are incorporated herein by reference.

Both triaryl and diaryl alkyl phosphate esters have been used to improve the flame retardancy of PVC. Nonetheless, continuing increases in demands in even better flame retardant properties for evermore stringent flexible PVC applications continue to challenge manufacturers.

The addition of dialkyl tetrahalophthalates such as dioctyl tetrabromophthalate or di-2-ethylhexyltetrabromophthalate has been able to achieve exceptional thermal stability and flame retardancy. The low temperature flexibility of PVC compounds is, however, compromised with the addition of such compounds.

There remains a continuing need in the art for even greater flexibility for PVC formulations and coatings.

When PVC burns, it gives off soot and suspended particles which are generally termed “smoke.” Although there is increasing demands for flexibility with thermal stability and flame retardancy, smoke generation is still an issue. As mentioned previously, the use of plasticizers necessary for flexibility and good processing properties generally increases the flammability of PVC compositions, especially if used at high levels. Although flame retardants are added to counteract the flammability of the plasticizers and reduce flammability of PVC compositions, they unfortunately increase smoke generation over the already considerable amount of smoke produced when PVC burns. In the case of plasticized PVC, the compounds forming the smoke can include not only the hydrocarbons, carbon oxides, and HCl from the PVC, but also the plasticizer compounds as well as their degradation products. The degradation products can also include aromatic and aliphatic hydrocarbons, carbon oxides, and hydrochloric acid. Smoke is particularly dangerous since it not only contains toxic by-products of combustion and thermal decomposition of the plastic. Smoke also restricts visibility and disorients potential victims, resulting in panic. Therefore, smoke suppressants, compounds which will inhibit the formation of smoke when the PVC composition burns, were developed.

The plastics industry has long recognized that the use of PVC in interior furnishings, building materials, and coverings for wire and cable presents the hazards of flame, toxic decomposition products, and smoke in the event of fire. It has therefore expended very considerable efforts to find additives for PVC which reduce smoke in the event that such PVC compositions are subjected to high temperatures or flame.

The most commercially recognized material for smoke suppression in PVC is ammonium octamolybdate (AOM). AOM is the premium material to make low smoke PVC compounds, particularly for plenum wire and cable applications. AOM is used in numerous PVC jacket formulations that pass the rigorous UL910 test for cables (copper conductor and fiber optic cables).

U.S. Pat. No. 4,153,792 discloses the production of amine molybdates as smoke suppressants, especially melamine molybdate by reacting an amine, such as melamine, with molybdenum trioxide in an aqueous acidic medium under reflux.

U.S. Pat. No. 4,217,292 also discloses the production of amine molybdates as smoke suppressants, preferably melamine molybdate by reacting an amine such as melamine with a stoichiometric quantity of molybdenum trioxide in an aqueous medium in the presence of an ammonium salt. The aqueous medium is essentially free of acid. The reaction may be conducted at temperatures within the range of 75-110° C.

Organic salts of divalent copper are also well known as smoke suppressants for polyvinyl chloride resins. Most studies were done using copper (II) acetate or copper (II) formate. These materials were designed to undergo decomposition to ground state copper (Cu°). This is referred to as a reductive coupling mechanism. Reductive coupling results in significant reduction of smoke upon ignition due to char formation. Copper in its ground state is active in reductive coupling of halogenated resins. The difficulty with copper (II) salts is two fold. The first difficulty is that the salts are blue or blue-green in color which also colors the resin systems. Secondly, the salts upon decomposition cause instability of the halogenated resin by dechlorination without reductive coupling. This dechlorination accelerates decomposition to olefinic species.

The use of melamine molybdate and copper compounds such as copper acetate, copper oxalate, and copper formate as smoke suppressants in halogenated resins, particularly PVC, is well known. This technology was never commercialized due to the technical failures of these systems. The pitfalls included blue to green discoloration of the resin systems, and poor thermal stability of the compounded resin systems, and loss of fire resistance characteristics due to the thermal instability of the compounded resin systems.

A variety of organic and inorganic compounds and salts have been proposed or used to reduce the smoke generation characteristics of rigid or plasticized PVC polymer compositions, but such agents have drawbacks such as not providing an improvement in smoke suppression for both rigid and plasticized PVC compositions, and unduly reducing the stability or processability of the polymer composition.

Another drawback with some agents employed to impart smoke suppression to PVC compositions unduly decrease the heat stability of the polymer compositions in which they are incorporated. In particular, some commercial smoke suppressant additives based on zinc compounds or combinations of zinc compounds with other compounds contain free zinc oxide, which can accelerate the degradation of PVC resins on exposure to temperatures above about 100° C.

In the area of PVC-based compositions for wire and cable covering applications, it is very desirable to have materials produce a minimum amount of smoke when burned, and produce light-colored smoke rather than dark smoke, while still possessing the good processing properties, mechanical toughness, and resistance to environmental stresses for which PVC compositions are known.

Accordingly, there is a continuing need for a PVC formulation having both high flexibility and very low smoke.

### SUMMARY OF THE INVENTION

A feature of this invention is to provide low temperature flexibility of highly flame retardant plasticized PVC compounds by incorporating into PVC, according to the discovery of the invention, a mixture of a dialkyl or dialkylene tetrahalophthalate containing both tetrabromophthalates and tetrachlorophthalates and a brominated and/or chlorinated paraffin.

A further feature of this invention is to provide a PVC formulation that exhibits a decrease in smoke generation.

Another feature of the invention is to provide an improved PVC formulation for use in products such as molding compositions to form molded articles, sheet materials, roofing materials, insulation, jackets, coatings and articles of clothing.

A further feature of the invention is to provide a polyvinyl chloride composition containing a dialkyl tetrahalophthalate and a halogenated paraffin where the dialkyl tetrahalophthalate is included in an amount sufficient to inhibit separation of the liquid halogenated paraffin from the polyvinyl chloride composition and provide the desired flexible characteristics. The dialkyl tetrahalophthalate when used in combination with the halogenated paraffin enables the halogenated paraffin to be used in amounts greater than when the halogenated paraffin is used alone.

In the present invention, it has been discovered that the addition of a halogenated paraffin to a PVC flexibilizing formulation comprising one or more tetrahalophthalates further lowers smoke generation, improves flame retardancy and improves low temperature brittleness without adversely affecting PVC flexibility. Such formulations are useful as outer jackets and insulators for plenum wires and cables, wire coverings, articles of clothing including weatherproof apparel, flexible layers under roof sheathing, other roll and sheet based layers used in residential and commercial construction, shingles or other roof coverings, and flexible coatings applied to fabrics.

The various aspects of the invention are basically attained by providing a flexible PVC composition comprising a polyvinyl chloride resin, at least one tetrahalophthalate plasticizer in an amount sufficient to promote flexibility of the PVC composition, and a halogenated paraffin in an amount to provide flame and smoke retardant properties.

These and other aspects of the invention will become apparent from the following detailed description of the invention which discloses various embodiments of the invention.

### DETAILED DESCRIPTION OF THE INVENTION

The present invention is directed to a polyvinyl chloride composition having flame retardant and smoke suppressing properties. The polyvinyl chloride compositions are suitable as molding compositions for forming molded articles, sheet goods such as roofing materials, coatings, coverings and insulation for wires and cables. The invention is further directed to a flame retardant and smoke suppressant agent that can be used in conjunction with a plasticizer for polyvinyl chloride resins. PVC containing at least one tetrahalophthalate, especially a mixture of tetrabromophthalate and tetrachlorophthalate, with a halogenated (especially brominated and/or chlorinated) paraffin show significant improvements in low temperature flexibility and decreased smoke generation potential. PVC compounds of the present invention also result in synergist improvements of flame retardancy with decreased smoke generation. The tetrahalophthalate is preferably a dialkyl or dialkenyl tetrahalophthalate.

PVC formulations according to one embodiment of the invention comprise: (A) a flexibilizing agent that includes one or more dialkyl or dialkenyl tetrahalophthalates, and (B) a smoke inhibitor that includes one or more halogenated alkyl hydrocarbons that are a liquid or solid form at 25° C. The halogenated alkyl hydrocarbons are preferably liquid halogenated paraffins. It has been found that the combination of the tetrahalophthalates and the halogenated paraffin provide improved flame and smoke retardancy than when the components are used individually in corresponding amounts without reducing the flexibility of the PVC composition.

The polyvinyl chloride composition of the invention preferably contains a mixture of at least one dialkyl or dialkenyl tetrahalophthalate and at least one halogenated paraffin where the various components do not separate from the PVC composition. The polyvinyl chloride composition in one embodiment includes at least 5 parts by weight and typically at least 10 parts by weight of the halogenated paraffin based on 100 parts by weight of the polyvinyl chloride resin. The dialkyl or dialkenyl tetrahalophthalate is included in an amount to provide the desired flexibility and to prevent the halogenated paraffin from separating or exuding from the polyvinyl chloride composition. It has been found that the halogenated paraffin can be added without reducing the flexibilizing properties of the tetrahalophthalate.

The dialkyl or dialkenyl tetrahalophthalate flexibilizing agents that can be used in the invention include one or more of fluoro-, chloro-, bromo-, and/or iodo-substituted dialkyl or dialkenyl tetrahalophthalates. Improved low temperature flexibility for PVC can be achieved with dialkyl tetrahalophthalate mixtures that are not adversely effected by the presence of the halogenated paraffin. Dialkyl tetrahalophthalates are disclosed in U.S. Pat. Nos. 6,534,575; 6,114,425 and 5,728,323, the disclosures of which are hereby incorporated by reference. Dialkyl or dialkenyl tetrahalophthalates useful in the present invention exhibit the following chemical structure:

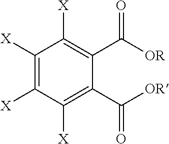

wherein:

R is an alkyl or alkenyl having 5-15 carbon atoms,

R′ is alkyl or alkenyl having 5-15 carbon atoms, and where R and R′ can be the same or different, and

X is independently F, Cl, Br or I.

In one preferred embodiment, R and R′ are independently a C₉-C₁₁ alkyl or alkenyl.

The dialkyl or dialkenyl tetrahalophthalates used in the PVC compound of the present invention may be prepared using methods known in the art. Preferably, the dialkyl tetrahalophthalates used in the PVC compound of the present invention are prepared in accordance with the teachings in U.S. Pat. No. 6,114,425 to Day et al, the disclosure of which is hereby incorporated by reference.

The tetrahalophthalate compounds provide improved low temperature flexibility, increased flame retardancy and decreased smoke generation of polyvinyl chloride resins.

Dialkyl tetrahalophthalate compounds useful in the present invention are preferably included at a concentration within the range of about 0.01-25% by weight based on total weight of the PVC composition depending on the degree of flexibility desired for the final product and the PVC material.

In one embodiment of the invention, two or more dialkyl tetrahalophthalates are used in combination. The weight ratio of the two dialkyl tetrahalophthalate flexibilizing agents in the mixture can be within the range from about 1:50 to about 1:1. In another embodiment a dialkyl tetrachlorophthalate can be used in combination with a dialkyl tetrabromophthalate preferably within the range of 1:10 to about 1:8, and most preferably about 1:4 to about 1:3 dialkyl. In one embodiment of the invention, the dialkyl tetrahalophthalate includes a mixture of dialkyl tetrachlorophthalate and dialkyl tetrabromophthalate where the mixture includes the dialkyl tetrachlorophthalate in an amount of about 1 to 99 wt %, preferably about 1 to 50 wt %, and more preferably about 25 to 33 wt % based on the total weight of the mixture.

The halogenated alkyl hydrocarbon smoke suppressing agents used according to the invention preferably include brominated and/or chlorinated alkyl compounds, preferably in the form of halogenated paraffinic materials. The smoke suppressing agents are preferably paraffinic hydrocarbons having a halogen content of about 30 wt % to about 70 wt % based on the weight of the paraffin. In one embodiment, the paraffin is liquid at room temperature and about 10-30 carbon atoms.

The halogenated paraffin can be a brominated paraffin, a chlorinated paraffin, a bromochlorinated paraffin, and mixtures thereof produced from a straight chain C₁₀ to C₂₀ alkyl. In one embodiment, the smoke suppressing agent is a bromochlorinated liquid paraffin having substantially equal amounts of bromine and chlorine by weight based on the weight of the liquid paraffin. In an embodiment of the invention, the liquid paraffin can have a bromine content of about 15 wt % to about 35 wt % and a chlorine content of about 15 wt % to about 35 wt % based on the total weight of the paraffin. In another embodiment, the liquid paraffin can have a bromine content of about 30 wt % to about 35 wt % and a chlorine content of 30 wt % to 3 wt % based on the total weight of the liquid paraffin.

Examples of suitable halogenated paraffins useful in the invention include commercially available liquid halogenated materials sold under the trade name DOVERGUARD (Dover Chemical Corporation, Dover, Ohio). DOVERGUARD 9119 (Dover Chemical Corporation, Dover, Ohio) is an example of one preferred material having 33 wt % bromine and 33 wt % chlorine in an unspecified variety of olefins that exhibits a Gardner color of 1, a viscosity of 65 poise at 25° C., and a specific gravity of 1.58 at 50° C. Commercially available halogenated paraffins are a mixture or blend of halogenated straight chain C₁₀-C₃₀ alkyls.

The halogenated paraffin can be used in an amount within the range of about 1-99% by weight based on the combined weight of the dialkyl tetrahalophthalate and halogenated paraffin mixture. In another embodiment, the halogenated paraffin is included in an amount of about 1 to 50 wt %, and more preferably 25 to 33 wt % based on the combined weight of the dialkyl tetrahalophthalate and halogenated paraffin mixture.

Mixtures of dialkyl tetrahalophthalate and halogenated paraffin can be prepared in any of a number of ways. For example, the dialkyl tetrahalophthalate flexibilizing agents can be mixed until homogeneous. The tetrahalophthalates can then be combined with the halogenated paraffin and added as a mixture to the PVC resin or the components can be added separately.

In one embodiment, the PVC formulation also includes a flame retardant synergist (e.g., antimony trioxide), a further plasticizer (e.g., trioctyl trimellitate), and/or a stabilizer (e.g., a calcium-zinc stabilizer).

The mixture or combination of the dialkyl tetrahalophthalate and halogenated paraffin are admixed with the polyvinyl chloride resin in an amount to provide the desired flexibility, flame and smoke retardancy. For example, the mixture or combined weight of the dialkyl tetrahalophthalate and halogenated paraffin can range from about 10 wt % to 25 wt %, and preferably about 15 wt % to 20 wt % based on the total weight of the polyvinyl chloride composition. In another embodiment, the combined weight of the dialkyl tetrahalophthalate and halogenated paraffin is about 20 parts by weight to about 40 parts by weight, and preferably about 25 parts by weight to 35 parts by weight based on 100 parts by weight of the polyvinyl chloride resin. The dialkyl or dialkenyl tetrahalophthalate is typically included in an amount of about 15-25 parts by weight, and preferably about 18-22 parts by weight based on 100 parts by weight of the polyvinylchloride. The halogenated paraffin is typically included in an amount of about 5-15 parts by weight, and preferably about 8-12 parts by weight based on 100 parts by weight of the polyvinyl chloride resin.

The finished polyvinyl chloride composition typically contains about 10 Wt % to about 12 wt % dialkyl tetrahalophthalate and about 5 wt % to about 7 wt % halogenated paraffin based on the total weight of the polyvinyl chloride resin composition. In other embodiments, the polyvinyl chloride composition can include the dialkyl tetrahalophthalate in an amount of about 5-20 wt % and the halogenated paraffin in an amount of about 3-10 wt % based on the total weight of the polyvinyl chloride composition.

It has been found that the combination of the dialkyl tetrahalophthalate and the halogenated paraffin provide improved flexibility and flame and smoke retardancy that cannot be obtained by the component individually. In particular, it has been found that the halogenated paraffin by itself has limited dispersibility in the polyvinyl chloride resin. Amounts of the halogenated paraffin without the use of the dialkyl tetrahalophthalate in amounts greater than 5 parts by weight per 100 parts by weight of the polyvinyl chloride resin separate and exuded from the resin composition as a sticky oil. When used in combination with the dialkyl tetrahalophthalate, the amount of the halogenated paraffin can be incorporated in amounts of at least 10 parts and up to 15 parts by weight based on 100 parts by weight of the polyvinyl chloride resin.

### EXAMPLES

For Examples 1-3, the base PVC polymer, plasticizer, stabilizer, flame retardant synergist, and the dialkyl tetrahalophthalate-brominated/chlorinated paraffin mixture were combined and thoroughly mixed. Initial mixing of the ingredients was carried out in a blender. The resulting charge was transferred to a 2 roll mill and preheated to 350° F. for fusion and further mixing. Rolling time was for 5 minutes under 1260 psi compression at 337° F. for compression molding of the mixture into test sheets.

The standard for PVC compression molding as known in the art is described in standardized test methods ASTM Designation: D-1928-90 and ASTM D-746, which are herein incorporated reference. Standardized test methods ASTM D-1928-90 and ASTM D-746 disclose the protocol for preparing compression molded polyethylene test sheets and PVC compression molding of the mixture into test specimens. In the present case, the specimens prepared according to these standards were subjected to physical, mechanical, and flame retardancy testing as described below.

Each example included tests to determine the tensile properties of the compressed PVC using standard dumbbell-shaped test specimens according to ASTM Designation D-638, published in 1995. In this test method, the test specimen is clamped by and between grips. The grips extend in opposed directions thereby stretching the test specimens until the specimen breaks. The test measures: (1) Tensile Modulus, which is the ratio of stress to corresponding strain below the proportional limit of a material and expressed in force per unit area (2) Tensile Strength at Break, which is the maximum tensile stress (tensile load per unit area of minimum original cross section) sustained by the specimen during a tension test at specimen break, and (3) Elongation, which is the elongation of a test specimen expressed as a percent of the gage length. An increase in these test factors indicates a more flexible test specimen.

Test specimen hardness was also measured. The standard hardness test method is found in the ASTM D-2240, published in 1995. This test results are based on the penetration of an indentor when forced into the test specimen.

Flame retardancy of the control and test formulations were determined by the Designation ASTM D-2863, published in 1995, to give oxygen index values. The oxygen index is equal to the minimum concentration of oxygen, expressed as volume percent, in a mixture of oxygen and nitrogen that will just support flaming combustion of a material initially at room temperature. A higher oxygen index indicates higher flame retardancy.

The test specimens were tested for the density of smoke generated by burning the test specimens in an NBS Smoke Chamber using the flaming mode in accordance with the ASTM E662-95 publication.

The test specimens were also tested for Brittleness Temperature. The brittleness of a test specimen is determined by immersing the specimen in a bath containing a heat transfer medium that is cooled. The specimens are struck at a striking element at a specified linear speed and then examined. The brittleness temperature is the temperature at which 50% of the specimens fail.

PVC resin (the base PVC resin used was GEON 30 from the Geon Corporation, now PolyOne Corporation) was compounded in a 2 roll mill in accordance with the procedures disclosed in ASTM D-1928 using the below mentioned Control and Test Formulations.

### Examples 1-3

Examples 1-3 were prepared and tested according to the procedures discussed above. The proportions, components and test results are presented in Table 1.

TABLE 1

| | Example 1 | | |
|---|---|---|---|
| | (CONTROL) | Example 2 | Example 3 |
| PVC Resin (Geon 30) | 100 | 100 | 100 |
| Trioctyl Trimellitate | 34.3 | 34.3 | 34.3 |
| (UNIPLEX 546-A) | | | |
| Bis (2-Ethylhexyl | — | 20 | — |
| tetrachlorophthalate | | | |
| Brominated/Chlorinated | — | 10 | 10 |
| Paraffin | | | |
| (DOVERGUARD 9119) | | | |
| Bis(2-Ethylhexyl | 30 | — | 20 |
| tetrabromophthalate) | | | |
| (UNIPLEX FRP-45) | | | |
| Antimony Oxide | 5 | 5 | 5 |
| Calcium-Zinc Stabilizer | 5 | 5 | 5 |
| Tensile Modulus at 100% | 1760 | 2070 | 1900 |
| Shore A Hardness (ASTM | 88 | 88 | 90 |
| D-224095, A Scale) | | | |
| Tensile Strength at Break | 2050 | 3480 | 3330 |
| (ASTM D638-95) | | | |
| Elongation (%)(ASTM | 278 | 390 | 360 |
| D638-95) | | | |
| Oxygen Index (ASTM | 33 | 37 | 41 |
| D2863-95) | | | |
| NBS Smoke(ASTM E662- | 440 | 240 | 265 |
| 95) | | | |
| Brittleness Temperature, | −12 | −40 | −32 |
| ° C. (ASTM D746-95) | | | |

The data in Table 1 shows that Examples 2 and 3 exhibited improved tensile modulus, tensile strength, elongation, oxygen index, smoke and brittleness relative to the control of Example 1. Both Examples 2 and 3, respectively, exhibited an 18% and 8% improvement in tensile modulus, 70% and 62% increase in tensile strength at break, 40% and 29% increase in tensile strength elongation, 12% and 24% increase in oxygen index, 45% and 40% decrease in NBS smoke and 233% and 167% increase in brittleness temperature.

The test data of Table 1 shows that the polyvinyl chloride resin composition that contain the halogenated paraffin exhibited an increase in tensile modulus, tensile strength, elongation, oxygen index, smoke and brittleness compared to Example 1 which contained only Bis-2-ethylhexyl-tetrabromophthalate. The differences between Examples 2 and 3 are due to the specific dialkyl tetrahalophthalate. Examples 2 and 3 which contained 10 parts by weight of the brominated/chlorinated paraffin exhibited no separation of the compound from the compositions. Previous samples prepared without the dialkyl tetrahalophthalate exhibit separation of the brominated/chlorinated paraffin when present in amounts greater than 5 parts by weight based on 100 parts by weight of the PVC resin.

While advantageous embodiments have been chosen to illustrate the invention, it will be understood by those skilled in the art that various changes and modifications can be made therein without departing from the scope of the invention as defined in the appended claims.

What is claimed is:

1. A flexible PVC composition comprising:
a polyvinyl chloride resin;
at least one dialkyl or dialkenyl tetrahalophthalate plasticizer in an amount sufficient to increase flexibility of said composition; and
at least one halogenated paraffin flame retardant in an amount to enhance flexibility at low temperatures and reduce brittleness of the composition.

2. The flexible PVC composition of claim 1, wherein said at least one dialkyl tetrahalophthalate comprises a mixture of dialkyl of tetrabromophthalate and dialkyl tetrachlorophthalate.

3. The flexible PVC composition of claim 1, wherein said composition comprises a mixture of a dialkyl tetrachlorophthalate and a dialkyl tetrabromophthalate in a ratio of about 1:4 to about 1:3 by weight.

4. The flexible PVC composition of claim 1, wherein said halogenated paraffin is included in an amount of at least 5 parts by weight per 100 parts by weight of the polyvinyl chloride resin.

5. The flexible PVC composition of claim 1, wherein said halogenated paraffin is included in an amount of at least 10 parts by weight based on 100 parts by weight of the polyvinyl chloride resin, and where the dialkyl tetrahalophthalate is included in an amount sufficient to inhibit separation of the halogenated paraffin from the polyvinyl chloride composition.

6. The flexible PVC composition of claim 1, wherein said halogenated paraffin is present in an amount within a range of about 25-33% by weight based on the combined weight of the halogenated paraffin and the dialkyl tetrahalophthalate.

7. The flexible PVC composition of claim 1, wherein said dialkyl tetrahalophthalate is included in an amount of about 1 wt % to about 99 wt % based on the combined weight of the dialkyl tetrahalophthalate and halogenated paraffin.

8. The flexible PVC composition of claim 1, wherein said dialkyl tetrahalophthalate is included in an amount of about 1 wt % to about 50 wt % based on the combined weight of the dialkyl tetrahalophthalate and the halogenated paraffin.

9. The flexible PVC composition of claim 1, wherein said dialkyl tetrahalophthalate is included in an amount of about 25 wt % to about 33 wt % based on the combined weight of the dialkyl tetrahalophthalate and the halogenated paraffin.

10. The flexible PVC composition of claim 1, wherein said dialkyl tetrahalophthalate is included in an amount of about 5-20 wt % and the halogenated paraffin in an amount of about 3-10 wt % based on the total weight of the polyvinyl chloride composition.

11. The flexible PVC composition of claim 1, further comprising a second plasticizer, a flame retardant synergist and a stabilizer.

12. The flexible PVC composition of claim 1, further comprising a trioctyl trimellitate plasticizer, antimony oxide, and a calcium zinc stabilizer.

13. The flexible PVC composition of claim 1, wherein the dialkyl tetrahalophthalate is selected from the group consisting of bis-2-ethylhexyl tetrachlorophthalate, bis-2-ethylhexyl tetrabromophthalate, bis-trimethylhexyl tetrabromophthalate, bis-isodecyl tetrabromophthalate, bis-isotridecyl tetrabromophthalate and bis-octyl tetrabromophthalate.

14. The flexible PVC composition of claim 1, wherein the dialkyl or dialkenyl tetrahalophthalate is a C₅ to C₁₅ alkyl or alkenyl tetrahalophthalate.

15. The flexible PVC composition of claim 1, wherein the halogenated paraffin is a liquid halogenated C₁₀-C₃₀ alkyl having a halogen content of about 30 wt % to about 70 wt % based on the total weight of the paraffin.

16. A PVC composition comprising:
polyvinyl resin;
a flame retardant synergist;
a stabilizer; and
a mixture of a dialkyl or dialkylene tetrahalophthalate and a halogenated paraffin in an amount effective to provide a predetermined flexibility fire retardant and smoke suppressant properties.

17. The flexible PVC composition of claim 16, wherein said mixture comprises about 1 wt % to about 50 wt % of said dialkyl or dialkenyl tetrahalophthalate based on the total weight of the dialkyl or dialkenyl tetrahalophthalate and halogenated paraffin.

18. The flexible PVC composition of claim 16, wherein said mixture comprises about 25 wt % to about 33 wt % of said dialkyl or dialkenyl tetrahalophthalate based on the total weight of said dialkyl or dialkenyl tetrahalophthalate and halogenated paraffin.

19. The flexible PVC composition of claim 16, wherein said composition comprises about 5-20 wt % of said dialkyl or dialkenyl tetrabromophthalate and about 3-10 wt % of said halogenated paraffin based on the total weight of the PVC composition.

20. The flexible PVC composition of claim 16, wherein said composition is a coating composition or molding composition.

21. The flexible PVC composition of claim 16, wherein said composition is in the form of a sheet.
